(19) United States
(12) Patent Application Publication
(10) Pub. No.: US 2021/0097517 A1
(43) Pub. Date: Apr. 1, 2021

(54) OBJECT OF INTEREST SELECTION FOR NEURAL NETWORK SYSTEMS AT POINT OF SALE

(71) Applicant: ZEBRA TECHNOLOGIES CORPORATION, Lincolnshire, IL (US)

(72) Inventors: Darran Michael Handshaw, Sound Beach, NY (US); Edward Barkan, Miller Place, NY (US); Eric Trongone, West Babylon, NY (US)

(21) Appl. No.: 16/584,380

(22) Filed: Sep. 26, 2019

(51) Int. Cl. G06Q 20/20; G06N 3/08; G06K 7/10; G06K 9/62; G06K 9/32

(52) U.S. Cl. CPC G06Q 20/208; G06N 3/08; G06K 9/3241; G06K 9/6256; G06K 7/1096

(57) ABSTRACT

A multi-plane imager device, such as a bi-optic barcode scanner, includes a color imager for generating color image data on a scanned object and a decode image for decoding an indicia on the object. Upon a decode event, the multi-plane imager, identifies one or more images corresponding to that decode event and sends those images for storage in an training image set for training a neural network. In some examples, imaging characteristics are used to identify only a portion of the images, so that only those portions are stored in the training image set. Example imaging characteristics include the Field of View(s) of the imager.

### BACKGROUND OF THE INVENTION

With increasing computing power, neural networks are now being used in image processing and recognition systems to identify objects of interest in an image. Neural networks provide predictive models for identification. Yet, the success of such predictions relies heavily on the quality and consistency of the input images used to train these neural networks. For a neural network to be effective, there should be a sufficient amount of image capture consistency, otherwise neural network training is hampered by too much variability in the training images.

Training neural networks using images captured by multi-plane imagers is particularly challenging. Example multi-plane imagers include imaging systems such as bi-optic imagers commonly used at point of sale (PoS) and self-checkout (SCO) locations.

One problem is that bi-optic imagers have tower (vertical) imagers and platter (horizontal) imagers that combine to create a very large imaging field of view (FOV). A large FOV is useful in that it encompasses an area large enough to capture an image of the object as it first enters a scan area. The bi-optic imager can thus detect the presence of the object, even before scanning that object for a barcode or other indicia. The large FOV also allows for scanning larger objects. However, the large imaging area also means that the color imager of the bi-optic might capture not only the desired object in an image, but other features to the left and right of the object (when viewed from above in the landscape view), including images gathered in a bagging or conveyer area.

Thus, the images captured over such large FOVs can be confusing to a neural network, because the neural network is unsure which of the many objects in an image is the object of interest that the neural network must classify. Indeed, many quick cashiers scan two objects at the same time to increase their checkout speed, but that often results in multiple objects captured in an image, which prevents the neural network from accurately identifying the object of interest building a classifier for that object. Further still, many images of an object include the cashier's hands, and providing such images to the neural network hampers training.

These large FOVs and other limitations of multi-planer imagers complicate the training of neural networks. Add to that the importance of having a neural network that continues to learn even after an initial learning process, there is particular need to develop techniques for accurately training a neural network capable of identify objects with increased accuracy, of adapting to new product packaging, and of incorporating new product offerings into a trained model.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of an example Point-of-Sale station showing a multi-plane imager in the form of a bi-optic barcode scanner, in accordance with an example.

FIG. 2 is a block diagram schematic of a multi-plane imager and a classification server for training a neural network based on image scan data and imaging characteristics received from the multi-plane imager, in accordance with an example.

FIG. 3 is a diagram of a process flow for identifying decode images and training a neural network based on an image set containing previously stored decode images, in accordance with an example.

FIGS. 4-6 illustrate top views of a bi-optic scanner having a large Field of View from a color imager, and a smaller, overlapping Field of View for a monochrome imager, where various imaging characteristics are used to identify a region of interest in the decode image, in accordance with an example.

FIG. 7 is a diagram of a process flow for identifying decode images and training a neural network based on a region of interest in decode images, where that region of interest is determined from imaging characteristics, in accordance with an example.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In example implementations, an imaging device is provided to capture images of an object in a scan area, in particular where the object includes an indicia for identifying the object. The image device identifies a decode event associated with that indicia, and identifies one or more images as corresponding to that decode event. These identified images may then be stored in an image set used to train a neural network or other machine learning process. In this way, an imaging device may capture multiple images of an object, identify images associated with the actual decoding of an indicia on that object, and then assign only those images to a training image set, excluding other images of the object not associated with that decode event. Implemented in large field of view (FOV) imagers like bi-optic scanners, such techniques can greatly reduce the number of images stored in an training image set and greatly improve the quality of those images, thereby generating more accurate trained classifications, and thus more accurate neural network prediction.

In example implementations, various computer-implemented processes for training a neural network are provided. These processes may be implemented entirely on imaging devices, in some examples. In other examples, the processes herein may be distributed across devices, where for example, some processes are performed by imaging devices and other processes are performed by servers or other computer systems connected to these imaging devices, via a communication network.

In example implementations, processes for training the neural network include collecting image scan data for an object in a scan area, e.g., through the use of an imager in a facility. That image scan data may include one or more images of the object, where those one or more images include full or partial indication of an indicia on the object. Example indicia include 1D, 2D, or 3D barcodes, or direct part marking (DPM) codes, by way of example. The processes of training the neural network may include identifying a decode event, for example, when an image has decoded a scanned indicia. In response to the decode event, the process may collect a sequence of images of the object in the scan area, where that sequence includes an image captured at the time of decoding and one or more adjacently captured images.

In some implementations, the process includes identifying an image of interest (e.g., an image of an object that coincides with the point at which an indicia on that image was separately captured for successful decoding, e.g., a decode image) from among a sequence of images of the object, where the decode image corresponds to the decode event. The process further includes storing the decode image in an image set for use by the neural network for object detection. In examples implementations, the decode image and a plurality of bounding images are stored in the image set.

In some implementations, the process includes identifying a region of interest within the decode image, truncating the decode image to form an training image from the decode image, and storing the training image in a training image set used to train the neural network.

In some implementations, imaging characteristic data is determined. That imaging characteristic data corresponds to (i) a physical characteristic of an imager capturing the plurality of images of the object, (ii) a physical characteristic of object in the scan area, and/or (iii) a physical characteristic object obtained from the image scan data. Thus, the region of interest in the decode image may be identified based on one or more of these imaging characteristic data. Therefore, truncation of the decode image may occur based on the imaging characteristics.

Example imaging characteristics include physical characteristics of the imager such as the field of view of the imager. Other example physical characteristics include the location of the indicia on the object, the outer perimeter of the object, the pixels per module of the indicia, and the tilt of the region of interest. In some implementations, the process includes storing, along with the training image in the image set, truncation data identifying these imaging characteristics.

In some implementations, the process includes collecting a sequence of images of the object in the scan area at a plurality of different fields of view of the imager. The process may determine a default field of view from among that plurality, as the field of view that corresponds to the decode image. That default field of view may be used for capturing subsequent decode images that are then stored in the image set for use by the neural network. That way, the image set may contain images from one field of view and not all fields of view, thereby increasing the training speed of the neural network and its accuracy.

In some examples, the imaging device is a bi-optic imager, having multiple imagers, one in a tower portion thereof and another in platter portion thereof. Example bi-optic imagers include multi-plane bi-optic barcode scanners supported by a Point-of-Sale station or other workstation.

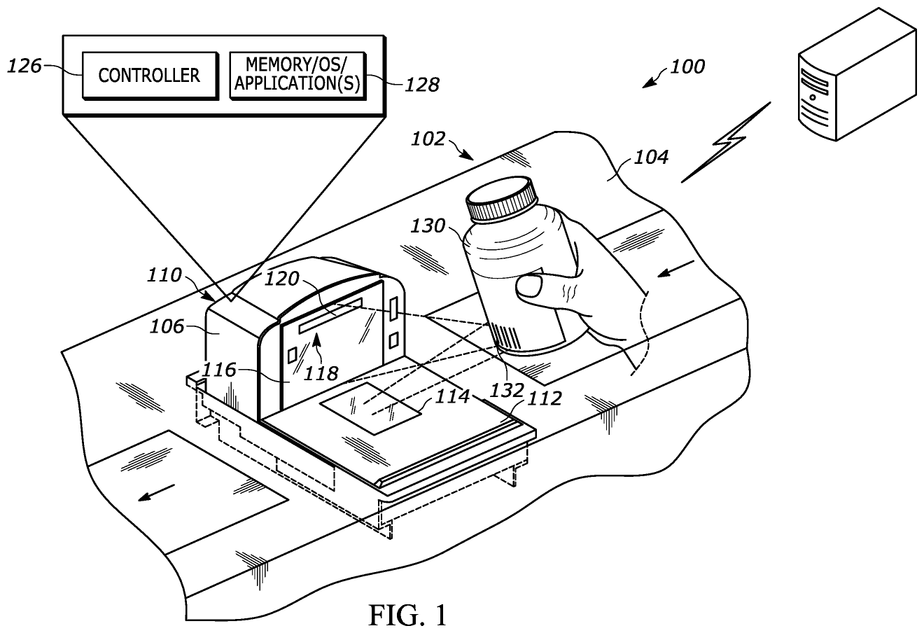

FIG. 1 illustrates a point-of-sale (POS) system 100 for scanning objects as part of a checkout process at a retail environment. The POS system 100 is part of a neural network system in which the POS system 100 is configured to capture image scan data, e.g., a plurality of images of an object in a scan area. The POS system 100 may be configured to determine imaging characteristics associated with image capture, in particular, characteristics such as physical characteristics of the imager, physical characteristics of the object in the scan area, and/or physical characteristics of the object obtained from the image scan data. The POS system 100 may be configured to identify a decode event corresponding to a determination of identification data associated with the object. The POS system 100 may be configured to identify a sequence of images of the object and determine a decode image from that sequence of images. That decode image is then stored in an image set for use by the neural network for object detection. In various examples, the POS system 100 may use the imaging characteristics to identify portions of the decode image and store those portions in a training image set for training (or updating the training) of the neural network.

In the illustrated example, the POS system 100 includes workstation 102 with a countertop 104 and a multi-plane imager 106 that captures images of objects such as the example item 130 over a scan area of the multi-plane imager 106. The POS 100 communicates the captured image scan data and imaging characteristics to a classification server 101 configured that includes a neural network of trained classifiers to identify objects from captured image scan data.

In the illustrated example, the multi-plane imager 106 is a bi-optical (also referred to as “bi-optic”) imager 106. The bi-optic imager 106 includes a lower housing (“platter”) 108 and a raised housing (“tower”) 110. The lower housing 108 includes a generally horizontal platter 112 with an optically transmissive window (a generally horizontal window) 114. The horizontal platter 112 may be positioned substantially parallel with the countertop 104 surface. As set forth herein, the phrase “substantially parallel” means+/−10° of parallel and/or accounts for manufacturing tolerances.

The raised housing 110 is configured to extend above the horizontal platter 112. The raised housing 110 includes a second optically transmissive window (a generally vertical window) 116. The vertical window 116 is positioned in a generally upright plane relative to the horizontal platter 112 and/or the first optically transmissive window 114. Note that references to “upright” include, but are not limited to, vertical. Thus, as an example, something that is upright may deviate from a vertical axis/plane by as much as 45 degrees.

The raised housing 110 includes an example illumination assembly 118. The illumination assembly 118 includes an illumination source 119, which is configured to emit a first illumination light at a first, monochromatic wavelength (e.g., at a red wavelength of 640 nm). The illumination assembly 118 may include a second illumination source 120 in the form of a white light illumination source configured to emit over a wide visible spectral region. More generally, the second illumination source 120 may be a polychromic, visible light source configured to simultaneously emit over a plurality of wavelengths in the visible spectrum. The illumination assembly 118 may include another illumination source 121 to emit non-visible light over a wide non-visible spectral region. The monochrome light source 119 may be used for scanning an indicia 132, such as a barcode, on an item 130. The white light illumination source 120 may be used to capture images of the item 130, in particular images captured by an imager within one or both of the raised housing 110 an the lower housing 108. These images form at least a portion of the image scan data. In some examples, the white light illumination source 120 is a white light lamp source. In some examples, the white light illumination source 120 is formed of a plurality of other light sources that collectively produce an illumination that spans the visible spectrum, such as a plurality of LEDs each emitting over different wavelength regions (e.g., red, green, and blue). In some examples, the white light illumination source 120 is tunable in response to a controller, to be able to emit an illumination at a particular wavelength within the visible spectrum or a particular combination of wavelengths. That is, the white light illumination source 120 may be configured to emit a monochromatic or poly-chromatic illumination at any tunable wavelength from approximately 390 nm to approximately 700 nm. In some further examples, a third illumination source may be used that emits in a non-visible region, such as in the infrared region.

In some examples, the bi-optic imager 106 is able to generate color images of the object 130, which allows for enhanced visibility of the object, enhanced imaging, and greater information captured in an image of the object, in comparison to monochromatic images. For barcode reading, the monochromatic illumination source 119 is sufficient. However, because the bi-optic imager 106 is used for classification with the server 101, capturing information on the image at different wavelengths provides for greater information capture and greater diversity of information capture.

The bi-optic imager 106 includes a controller 126, which may represent one or more processors, and a memory 128, which may represent one or more memories. In operation, the controller 126 causes the illumination assembly 118 to illuminate when the object (item) 130 is swiped past the bi-optic imager 106. For example, the bi-optic imager 106 may detect the object 130 in a Field of View (FOV) extending horizontally from the raised portion 110, in a FOV extending vertically from the lower housing 108, or a combination of the two. Such detection may occur upon an edge of the object entering any FOV of the imager, for example. Upon detection, the controller 126 may instruct the illumination source 119 to perform a monochromatic scan to identify a barcode or other indicia on the object 130. An imager 129 within the bi-optic imager 106 captures the monochromatic image. Upon the detection, the controller may also instruct the illumination source 120 to illuminate the item 130 with a white light illumination or tuned monochromatic or polychromatic illumination. In response, a white light image of the object 130 is captured by the image 129, as well. That is, the imager 129 may be a high resolution color camera, capable of capturing monochromatic images under monochromatic illumination and color images under white light illumination.

The imager 129 may capture color images through one or both of windows 114 and 116. That is, in some examples, the imager 129 is positioned and angled within the bi-optic imager 106 to capture images from a horizontally facing FoV from window 116, a vertically facing FoV from window 114, or from a combination of the two FoVs. The color imager may be a one dimensional (1D), two-dimensional (2D), or three-dimensional (3D) color imager, for example. In some examples, the imager 129 represents a plurality of color images within the bi-optic imager 106, e.g., one in the tower portion and another in a platter portion.

In some examples, the bi-optic imager 106 may include a dedicated monochrome imager 127 configured to capture monochromatic images (e.g., B/W images) of the object, for example, in response to illumination of the object 130 by the monochromatic illumination source 121.

Multi-dimensional images can be derived by combining orthogonally positioned imagers. For example, 1D color image sensed from a tower portion of the bi-optic scanner and a 1D monochromatic (“B/W”) image sensed from a platter portion of the bi-optic scanner can be combined to form a multi-dimensional image. Other combinations of images may be used as well.

While the white light illumination source 120 is shown in the raised portion 110, in other example, the white light illumination source may be on the lower portion 108. In yet other examples, each portion 108 and 110 may have a white light illumination source.

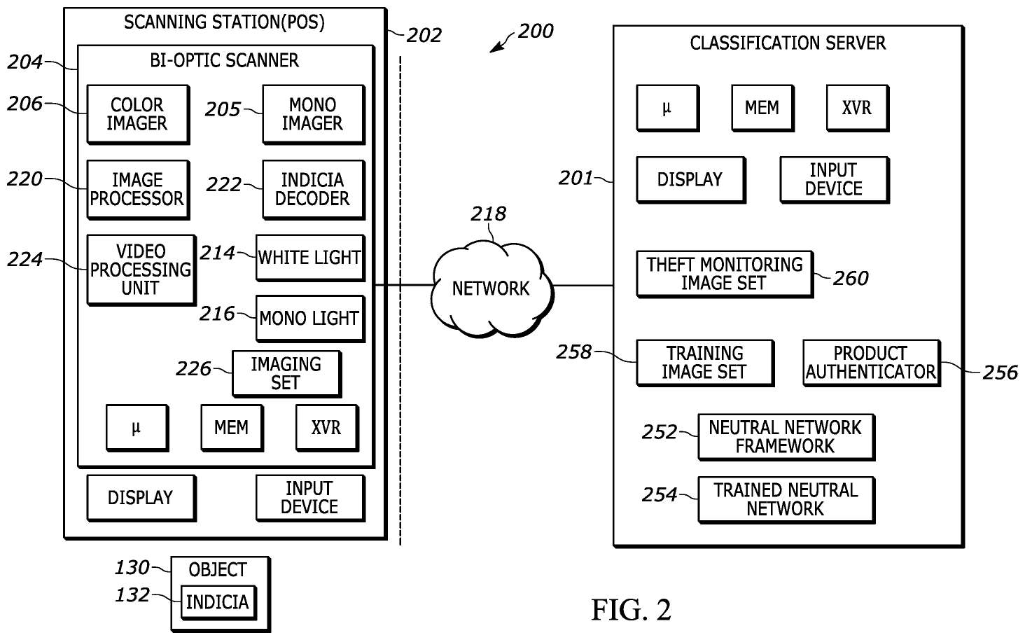

FIG. 2 illustrates a classification system 200 having a scanning station 202, such as a POS scanning station, and classification server 201. The scanning station 202 includes a bi-optic imager 204, which may be the bi-optic imager 106 of FIG. 1. The bi-optic imager 204 may include one or more monochrome imagers 205, a color imager 206, white light illumination source 214, and an optional monochromatic illumination source 216, each functioning in a similar manner to corresponding elements in the bi-optic imager 106 and other descriptions herein.

Additionally, the bi-optic imager 204 includes a controller, which may be one or more processors (“μ”) and one or memories (“MEM”), storing instructions for execution by the one or more processors for performing various operations described herein. The bi-optic imager 204 includes one or more transceivers (“XVR”) for communicating data to and from the classification server 201 over a wired or wireless network 218, using a communication protocol, such as Ethernet, WiFi, etc.

The bi-optic imager 204 further includes an image processor 220 and an indicia decoder 222. The image processor 220 may be configured to analyze captured images of the object 130 perform preliminary image processing, e.g., before image scan data is further processed and sent to the classification server 201. In exemplary embodiments, the image processor 220 identifies the indicia 132 captured in an image, e.g., by performing edge detection and/or pattern recognition, and the indicia decoder 222 decodes the indicia and generates identification data for the indicia 132 and generates a flag indicating a decode event has occurred when the indicia 132 is successfully decoded. The bi-optic imager 204 may sends identification data, image scan data, and imaging characteristics data to the classification server 201 for use by the server 201 in identifying the object 130 and/or for use in training a neural network of the classification server.

The bi-optic imager 204 further includes a video processing unit 224 that receives image scan data from the image processor 220. In some examples, the video processing unit 224 may be implemented on the image processor 220. In other examples, one or more of the processes of the video processing unit 224 may be implemented on the classification server 201. In some implementations, the video processing unit 224 receives the image scan data from the processor 220 and receives an indication of a decode event from the decoder 222, corresponding to a determination of identification data associated with the indicia. The video processing unit 224, collecting a sequence of images of the object, flags one of the sequence of images as corresponding to that decode event, and that flagged image becomes a decode image. Thus, the video processing unit 224 identifies from among the captured images, the image captured at the time the indicia for that object was decoded, or captured at a time shortly thereafter. As the object is moved across a scan area of the bi-optic imager 106, the orientation and distance of the object may change as it moves across the horizontal and/or vertical FOVs. Therefore, the decode image may be an image of the object having the same or nearly the same orientation and distance to imager as the indicia of the object when it was captured by the monochrome imager and decoded. The video processing unit 224 may receive images captured from a color imager of a bi-optic imager, whether that imager is in a tower thereof, a platter thereof, or a combination of the two. In some implementations, the video processing unit 224 identifies the decode image and a plurality of bounding images, such as one or more images captured sequentially with the decode image, immediately preceding the decode, immediately succeeding the decode image, or some combination of those. In some examples, the video processing unit 224 can communicate the decode image to the classification server 201 or the decode image and the bounding images to the server 201 for use by a neural network.

The scanning station 200 may further include a digital display and a input device, such as a keypad, for receiving input data from a user.

While not shown, the bi-optic imager 204 may include additional sensors, such as an RFID transponder for capturing indicia data is the form of an electromagnetic signal captured from an RFID tag associated with an object. Thus, the decoding of an RFID on an object may be the decode vent that triggers a video processing unit to determine a decode image.

The classification server 201 is configured to execute computer instructions to perform operations associated with the systems and methods as described herein. The classification server 201 may implement enterprise service software that may include, for example, RESTful (representational state transfer) API services, message queuing service, and event services that may be provided by various platforms or specifications, such as the J2EE specification implemented by any one of the Oracle WebLogic Server platform, the JBoss platform, or the IBM WebSphere platform, etc. Other technologies or platforms, such as Ruby on Rails, Microsoft .NET, or similar may also be used.

The classification server 201 includes one or more processors (“μ”) and one or memories (“MEM”), storing instructions for execution by the one or more processors for performing various operations described herein. The server 201 includes a transceiver (“XVR”) for communicating data to and from the bi-optical imager 204 over the network 218, using a communication protocol, such as WiFi. The classification server 201 may further include a digital display and an input device, such as a keypad.

The classification server 201 includes a neural network framework 250 configured to develop a trained neural network 252 and to use that trained neural network to classify objects based image scan data from the scanning station 202, as described herein. In some examples, the neural network framework 250 trains the neural network 252 based on image scan data and imaging characteristics obtained by the scanning station 202. More particularly, in some examples, the neural network framework 250 trains the neural network 252 based on decode images, and in some examples based on truncated versions of those decode images, for example, where the decode image has been truncated based on an identified region of interest in the image and/or based on imaging characteristics.

The neural network framework 250 may be configured as a trained prediction model assessing received images of an object (with or without indicia) and classifying those images to identify the object among possible objects in a retail environment, warehouse environment, distribution environment, etc. That determination may be used to approve or reject an attempted purchased at a Point-of-Sale, for example. In various examples herein, a prediction model is trained using a neural network, and as such that prediction model is referred to herein as a “neural network” or “trained neural network.” The neural network herein may be configured in a variety of ways. In some examples, the neural network may be a deep neural network and/or a convolutional neural network (CNN). In some examples, the neural network may be a distributed and scalable neural network. The neural network may be customized in a variety of manners, including providing a specific top layer such as but not limited to a logistics regression top layer. A convolutional neural network can be considered as a neural network that contains sets of nodes with tied parameters. A deep convolutional neural network can be considered as having a stacked structure with a plurality of layers. In examples herein, the neural network is described as having multiple layers, i.e., multiple stacked layers, however any suitable configuration of neural network may be used.

CNNs, for example, are a machine learning type of predictive model that are particularly using for image recognition and classification. In the exemplary embodiments herein, for example, CNNs can operate on 2D or 3D images, where, for example, such images are represented as a matrix of pixel values within the image scan data. As described, the neural network (e.g., the CNNs) can be used to determine one or more classifications for a given image by passing the image through the series of computational operational layers. By training and utilizing these various layers, the CNN model can determine a probability that an image or physical image features belongs to a particular class, e.g., a particular object in a retail environment. Trained CNN models can be persisted for restoration and use, and refined by further training. Trained models can reside on any in-premise computer volatile or non-volatile storage mediums such as RAM, flash storage, hard disk or similar storage hosted on cloud servers.

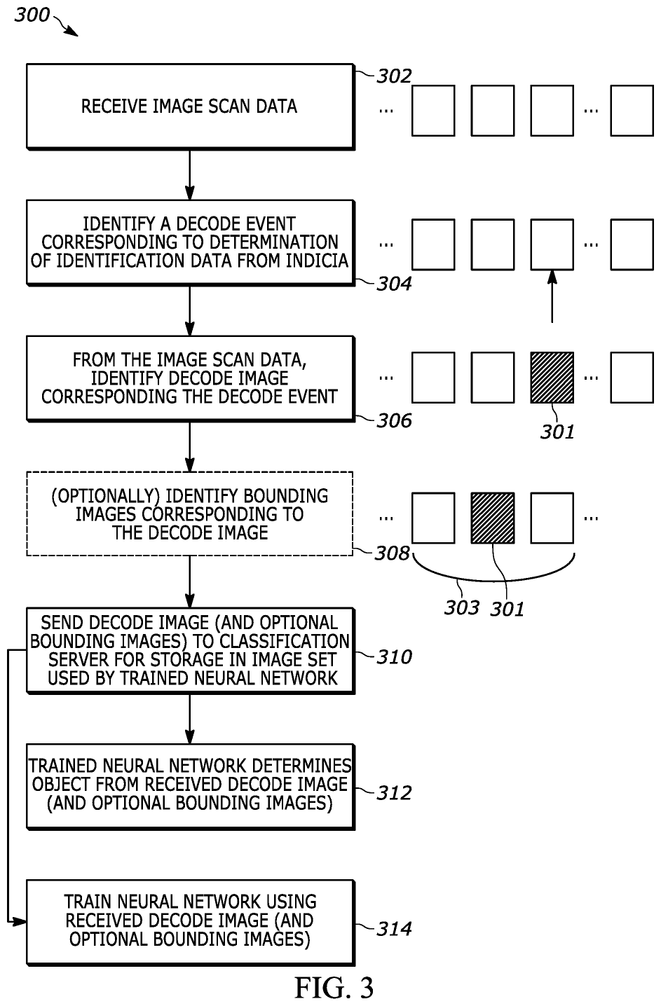

FIG. 3 shows an example process 300 for providing images to a trained neural network for training and/or identifying an object contained in those images. A process 302 receives image scan data including a plurality of images of an object, for example, images captured by the color imager 206 of the bi-optic imager 204. In some implementations, the image scan data is received at the imaging device that capture the images, e.g., at a bi-optic imager. In some implementations, the captured images are sent to the video processing unit 224 or an external processing device, such as a server.

At a process 304, a decode event is identified, where that decode event corresponds to the determination of identification data from the indicia 132. In some examples, the process 304 is implemented by the video processing unit 224, which receives the determination of the identification data from the indicia decode 222 and thereby identifies the presence of a decode event. In some examples, the process 304 may further include the actual indicia decoder 222 identifying a decode event by collecting image data from the monochrome imager 205, identifying the indicia 132 in the image data, and decoding the indicia 132 to determine identification data associated with that indicia.

At a process 306, the video processing unit 224 identifies, from the plurality of received images, an image of interest 301 (termed a decode image in FIG. 3) corresponding to the decode event. Such identifying of the image of interest (e.g., decode image) may comprise identifying the image of interest using an identification, buffering the image of interest, or otherwise providing an indication of the image of interest for further analysis.

At an optional process 308, the video processing unit 224 may further identify bounding images 303 corresponding to the decode image. For example, the bounding images may be sequentially preceding and/or a sequentially succeeding set of captured images.

The video processing unit 224 sends the decode image and optionally any bounding images to the classification server 201, at the process 310, and the trained neural network 254 determines object identification data by applying its trained classifiers on the received image(s), at process 312. In some examples, the video processing unit 224 sends the decode image and optionally any bounding images to the classification server, which uses the image(s) to train or further train the neural network, at process 314.

To identify the object, the process 312 applies the sent images to the trained neural network 254 of the classification server 201, where the classification server is implemented as a product identification server. For example, the scanning station 202 may decode an indicia and determine a product associated with decoded indicia. In other examples, the classification server 201 may perform this process in response to indicia data from the scanning station 202. In any case, the classification server 201, receiving the decode image form the scanning station 202 may determine a product associated with the decode image by applying the decode image to the classifiers of the trained neural network 254. The classification server 201, at a product authenticator 256, then compares the product determined from the indicia to the product determined by the trained neural network 254 from the decode image. When the comparison results in a match, the decode image is then stored in a training image set 258 of the server 201. When the comparison results in a non-match, the decode image is not stored, because the decode image has not been confirmed as corresponding to the indicia that was decoded from. In this way, a further authentication of the decode image (and any bounding images) may be performed before the decode image is stored in the image set 258 for training the neural network 254. Indeed, in some examples, decode images that do not correspond to the decoded indicia may instead be stored in a theft-monitoring image set 260. This theft-monitoring image set 260 may be used to train the neural network 254 to develop theft classifiers that identify images of an object, with certain characteristics, and classify those images as images of attempted theft of the object, such as attempted sweethearting scans of an object, with incorrect indicia attached to it.

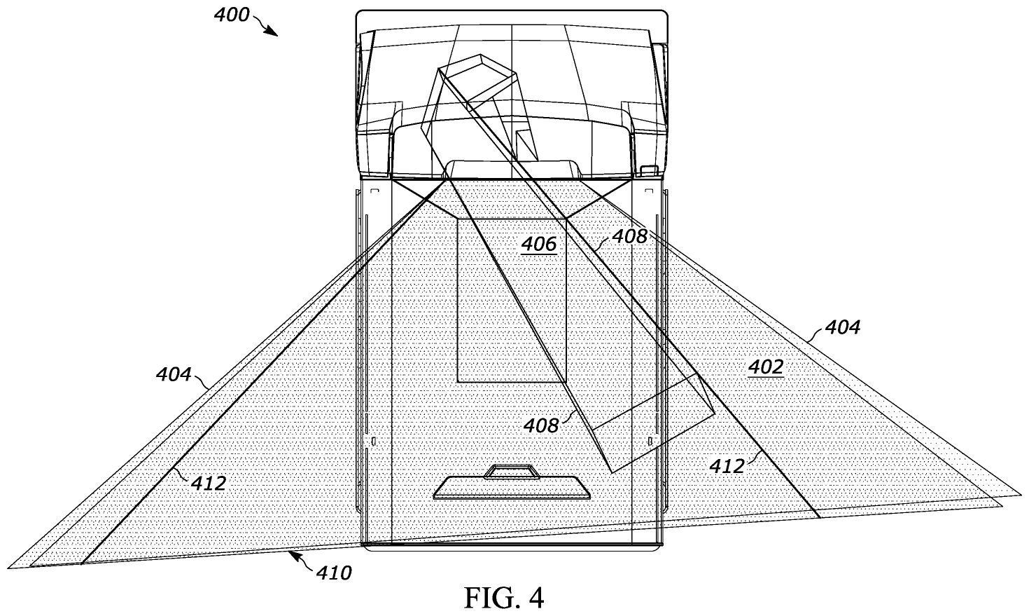

FIGS. 4-6 illustrate a bi-optic imager 400 capable of capturing images of an object over a large FOV. As shown, the bi-optic imager 400 has a very large vertical FOV 402 over which it can capture images. The FOV 402, bounded by edges 404, may be that of a color imager, for example. The bi-optic imager 400 may be configured to capture images over the entire FOV 402 and send those to a classification server. However, the bi-optic imager 400 is further configured to capture an image over only a portion of the FOV 402 and send that image to the classification server. In some examples, the bi-optic imager 400 is yet further configured to truncate a captured image to coincide with only a portion of the FOV 402 and send that truncated image to the classification server.

In addition to the FOV 402, the bi-optic imager 400 defines a second field of view, FOV 406, that corresponds to a monochrome imager used for capturing the image of an indicia for decoding that indicia. The FOV 406 (in this case a vertical left FOV) is bounded by edges 408 and coincides with only a portion of the FOV 402, at least when looking from above. Each of the FOV 402 and FOV 406 are examples of imaging characteristics, in particular physical characteristics of the imager.

In some examples, the bi-optic imager 400 (e.g., an image processor therein or a video processing unit therein) is configured to capture image scan data and determine imaging characteristic data, such as the FOVs of the imager. The bi-optic imager 400 then identifies a region of interest within a captured image based on these imaging characteristics. For example, a region of interest 410 is shown in FIG. 4. That region of interest 410 is defined as the portion of the FOV 402 that fully encompasses the FOV 406. The region of interest 410 is thus bounded by edges 412 from a top view. The region of interest 410 may be bounded by top and bottom edges (not shown) in a end on view. The bi-optic imager 400 can take a captured image, e.g., an identified decode image, and truncate that image to the region of interest 410. By truncating the images to coincide with the region of interest 410, the bi-optic imager 400 can send images for storage that exclude objects that fall completely outside of pixels that do not cross the monochrome imager (i.e., decoder image) field of view.

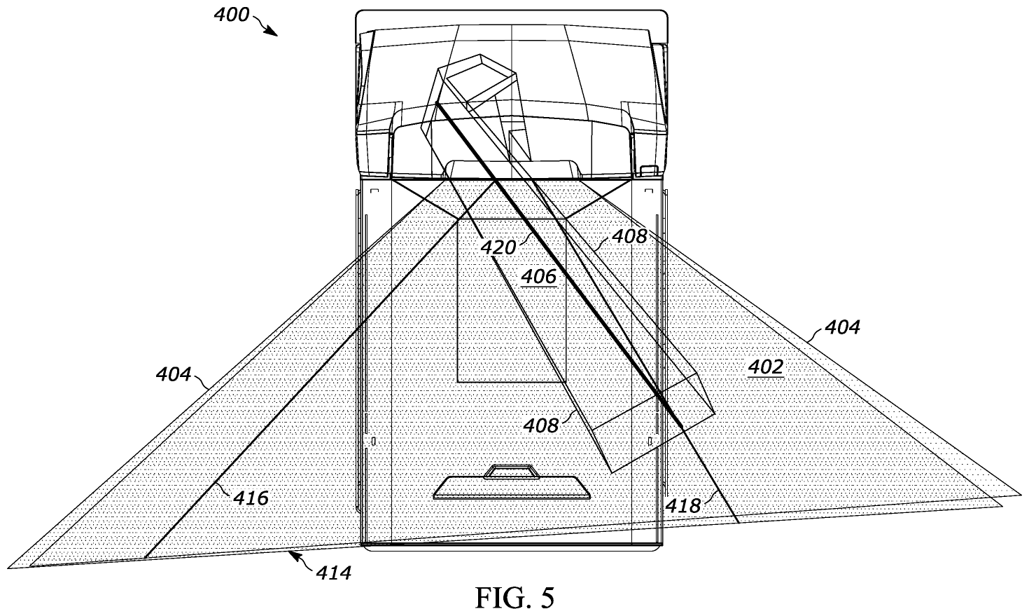

FIG. 5 illustrates another example region of interest determination, where the region of interest has been further narrowed by including imaging characteristics of the actual object, where the bi-optic imager 400 determines those imaging characteristics from the image scan data. In some implementations, the imaging characteristics are physical characteristics of the object such as the size or location of the indicia on the object. For example, the size or location of the indicia can be determined from any image captured by the bi-optic imager 400, including image scan data captured by a monochrome imager, a sequence of images captured by a color imager, etc. Any of these images may be analyzed to identify the size and/or location of indicia on an subject. By having the indicia decoder determine which pixels correspond to the indicia, for example, the bi-optic imager 400 can identify a further narrowed portion of the FOV 406, i.e., region of interest 414 bounded on one side by an edge 416 and on another side with an edge 418 (both from a top view, with top and bottom edges now shown) that coincides with where the indicia of an object is located within the FOV 406 shown by a bounding line 420. The result is a region of interest 414 (FIG. 5) that is much smaller than the region of interest 410 (FIG. 4).

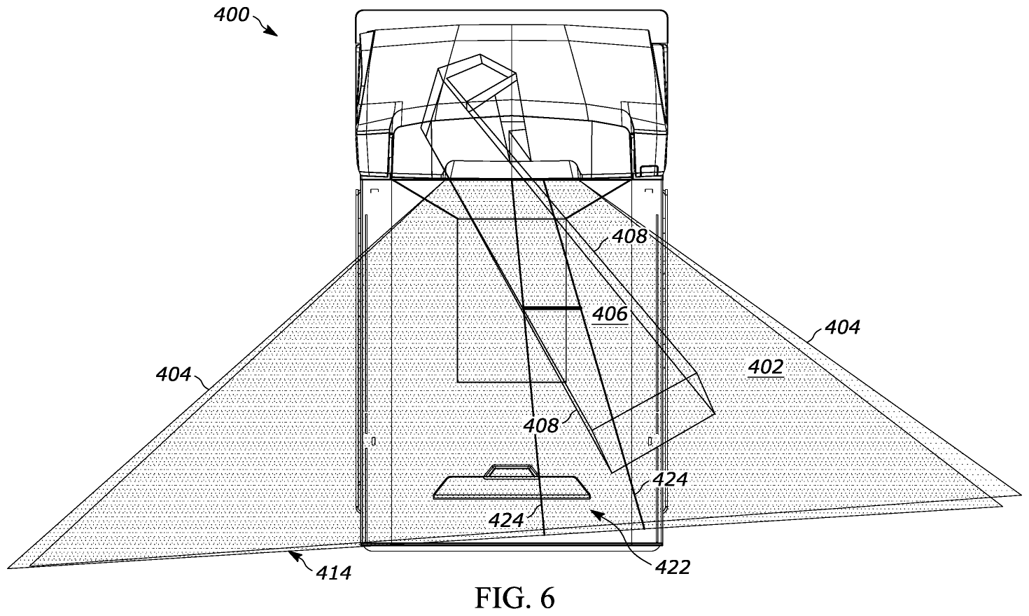

FIG. 6 illustrates yet another example, in which the imaging characteristics include the pixels per module (PPM) of the decoded indicia, in this case a decoded barcode. By the indicia decoder determining the PPM, for example, the bi-optic imager 400 may determine an even narrower region of interest 422. For example, by determining the PPM, and compare to stored, known PPM values, the bi-optic imager 400 can predict a distance to the indicia on the object, as measured from the monochrome imager. With that distance known, the bi-optic imager 400 can know where the indicia is located within the FOV 402 and use that to define a region of interest 422 that coincides specifically with that indicia, bounded by edges 424 (both from a top view, with top and bottom edges now shown).

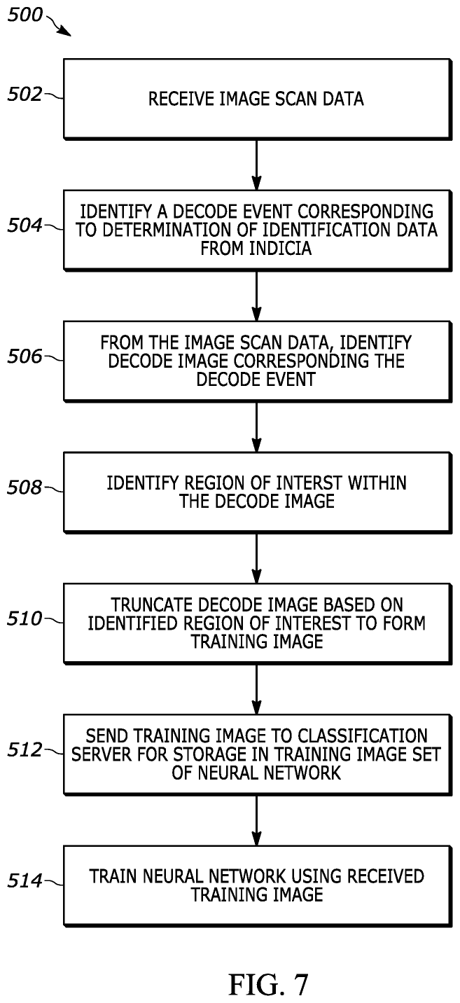

FIG. 7 shows an example process 500 for providing images for use in training a neural network. A process 502 receives image scan data including a plurality of images of an object, for example, images captured by a color imager of a bi-optic imager. Similar to process 304, a process 504 identifies a decode event corresponding to the determination of identification data from an indicia on the object. At a process 506, similar to process 306, a decode image is identified from among the images in the image scan data. Further, while not shown, a plurality of bounding images may be identified as well.

Instead of sending the decode image to the classification server for storage in a training image set, at a process 508, the bi-optic imager identifies a region of interest within the decode image and applies a process 510 that truncates the decode image, based on that region of interest, to form a training image. The bi-optic imager then sends (process 512) that training image to the classification server which trains the neural network using the training image, at a process 514.

In some implementations, the process 508 identifies the region of interest by determining imaging characteristic data corresponding to (i) a physical characteristic of an imager capturing the plurality of images of the object, (ii) a physical characteristic of object in the scan area, and/or (iii) a physical characteristic object obtained from the image scan data. The region of interest within the decode image is then identified based on the imaging characteristic data.

The physical characteristics may be the field of view of an imager, for example, a color imager, a monochrome image, or both. The physical characteristics may be the location of an indicia on an object, the outer perimeter of the object, or the pixels per module (PPM) of the indicia on the object. The physical characteristic may be a tilt of the indicia in the decode image, which can be determined by performing imaging processing on the PPM of the indicia. For a multi-plane imager, the physical characteristic may be a vertical imager FOV and a horizontal imager FOV, where one or both of those imagers are color imagers or monochrome imagers.

In yet further examples, the physical characteristic may be an anomaly identified as present within a region of interest in the decode image. For example, an imager may be configured to identify an anomaly such as the present of a hand in the decode image or the presence of environmental features at a point of sale station but that are independent and irrespective of the object itself. The imager (e.g., a video processing unit or image processor thereof) may be configured to identify such anomalies and determine if the anomalies are present in an amount that exceeds a threshold, then the process 500 may prevent the truncation of the decode image and prevent the sending of the decode image to the classification server for storage in a training image set. The amount of anomaly present may be determined by totaling the number of pixels in a decode image and comparing to the total number of pixels in the anomaly region. In examples where the imager examines for anomalies in a previously identified region of interest within the decode image, then the total pixels of the anomalous portion may be compared against the total pixels in the region of interest to determine if a threshold has been reached. Ratios of anomalous region to total region of 20% or higher, 30% or higher, 40% or higher, 50% or higher, 60% or higher, 70% or higher, 80% or higher, or 90% or higher may be used to determine the threshold.

In some examples, the process 512 sends to the classification server, training images and truncation data identifying (i) the physical characteristic of the imager used to form the training image, (ii) the physical characteristic of object in the scan area used to form the training image, and/or (iii) the physical characteristic object obtained from the image scan data used to form the training image. The classification server may use the truncation data in training the neural network.

In some implementations, as part of region of interest identification, the process 508 may analyze the decode image and determine if the decode image contains more than one indicia. If only one indicia is identified, the process 508 sends the region of interest to the process 510 for truncating the decode image. If multiple indicia are present, however, the process 508 does not send the decode image to the process 510, but rather the process 500 terminates or restarts.

In some implementations, the bi-optic imager may determine a product associated with an image of interest, by analyzing any of the sequence of images captured of the object. For example, the bi-optic image may identify and decode an indicia in any of that sequence of images. In some implementations, the bi-optic imager determines if one or more of the sequence of images contains more than one indicia. If so, then the bi-optic imager can prevent a corresponding image of interest, associated with the decode event, from being stored in training image set. In some implementations, such determination of multiple indicia may be made on the image of interest associated with the decode event. The bi-optic imager may perform similar analysis determining if one or more of the sequence of images, including for example, the image of interest associated with the decode event, contains more than object. If the image does, then the bi-optic imager can provide the image of interest from being stored in a training image set.

In some implementations, the bi-optic imager may collect images at a plurality of different fields of view of the imager, e.g., at FOV for a platter imager and another FOV for a tower imager or at any number of FOVs for any such orientations. The bi-optic imager may then, after determining a decode image, determine the FOV associated with that decode image. For example, the decode image may correspond to an image captured by a tower color imager that captures the indicia, while a platter color imager capturing an image of the same object at the decode event has not captured an image of the indicia (or has not captured a sufficiently complete image of the indicia). It is not uncommon for a cashier to scan an object with a preference for reading an indicia through the tower imager rather than a platter imager. In such examples, the bi-optic imager not only identifies the decode image but which FOV corresponds to that decode image. This may be determined by the image processor or video processing unit within an imager. Once the decode image FOV is determined, that FOV may be set as the default FOV for subsequent imaging by the imager. As such, decode images captured only over that default FOV may be used for identifying an object using the neural network or used for training the neural network. Images captured in other FOVs would not be sent to the classification server in such examples.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method for training a neural network, the method comprising:
receiving, at one or more processors, image scan data, wherein the image scan data is collected from an object in a scan area and wherein the image scan data is of an indicia on the object;
identifying, at the one or more processors, from the received image scan data, a decode event corresponding to a determination of identification data associated with the indicia;
responsive to identifying the decode event, collecting, at the one or more processors, a sequence of images of the object in the scan area and identifying, at the one or more processors, an image of interest from among the sequence of images of the object, the image of interest corresponding to the decode event; and
storing the image of interest in an image set for use by the neural network for object detection.

2. The computer-implemented method of claim 1, further comprising:
identifying, at the one or more processors, the image of interest and a plurality of bounding images from among the sequence of images of the object; and
storing the bounding images in the image set for use by the neural network.

3. The computer-implemented method of claim 2, wherein the bounding images comprise a preceding and/or a succeeding set of images from among the sequence of images of the object.

4. The computer-implemented method of claim 1, wherein identifying the image of interest from among the sequence of images of the object, further comprises:
identifying, at the one or more processors, a region of interest within the image of interest;
truncating, at the one or more processors, the image of interest to form a training image from the image of interest; and
storing the training image in a training image set for use by the neural network.

5. The computer-implemented method of claim 4, further comprising:
determining imaging characteristic data corresponding to (i) a physical characteristic of an imager capturing the plurality of images of the object, (ii) a physical characteristic of object in the scan area, and/or (iii) a physical characteristic of the object obtained from the image scan data;
identifying, at the one or more processors, the region of interest within the image of interest based on the determined imaging characteristic data; and
truncating the image of interest to form the training image as an image of the object corresponding to the region of interest such that the training image is a truncation of the image of interest.

6. The computer-implemented method of claim 5, wherein the physical characteristic of the imager is a field of view of the imager.

7. The computer-implemented method of claim 5, wherein the imager is a tower imager of a bi-optic scanner.

8. The computer-implemented method of claim 5, wherein the imager is a platter imager of a bi-optic scanner.

9. The computer-implemented method of claim 5, wherein the physical characteristic of the object is a location of the indicia on the object obtained from the image scan data.

10. The computer-implemented method of claim 5, wherein the physical characteristic of the object is an outer perimeter of the object.

11. The computer-implemented method of claim 5, wherein physical characteristic of the object obtained from the image scan data is a pixels per module of the indicia.

12. The computer-implemented method of claim 5, wherein physical characteristic of the object is a tilt of the image scan data, as determined from analyzing the pixels per module of the indicia across the sequence of images.

13. The computer-implemented method of claim 5, further comprising:
storing, along with the training image in the image set, truncation data identifying (i) the physical characteristic of the imager used to form the training image, (ii) the physical characteristic of object in the scan area used to form the training image, and/or (iii) the physical characteristic object obtained from the image scan data used to form the training image.

14. The computer-implemented method of claim 1, further comprising:
decoding the indicia identified from the received image scan data and determining a product associated with decoded indicia;
analyzing the image of interest and determining a product associated with the image of interest; and
comparing the product associated with the decode indicia to the product associated with the image of interest and when the comparison results in a match, storing the image of interest in the image set and when the comparison results in a non-match preventing the storing of the image of interest in the image set.

15. The computer-implemented method of claim 1, further comprising:
decoding the indicia identified from the received image scan data and determining a product associated with decoded indicia;
analyzing the image of interest and determining a product associated with the image of interest; and
comparing the product associated with the decode indicia to the product associated with the image of interest and when the comparison results in a match, storing the image of interest in the image set and when the comparison results in a non-match the storing of the image of interest in a theft-monitoring image set.

16. The computer-implemented method of claim 1, further comprising:
analyzing at least one of the sequence of images of the object and determining a product associated with the image of interest by identifying and decoding an indicia in the at least one of the sequence of images.

17. The computer-implemented method of claim 1, further comprising:
analyzing at least one of the sequence of images of the object and determining if the at least one of the sequence of images contains more than one indicia; and
when the at least one of the sequence of images does not contain more than one indicia storing the image of interest in the image set, and when the at least one of the sequence of images contains more than one indicia preventing the storing of the image of interest in the image set.

18. The computer-implemented method of claim 1, further comprising:
analyzing the image of interest and determining if the image of interest contains more than one object; and
when the image of interest does not contain more than one object storing the image of interest in the image set, and when the image of interest contains more than one object preventing the storing of the image of interest in the image set.

19. The computer-implemented method of claim 1, further comprising:
collecting the sequence of images of the object in the scan area at a plurality of different fields of view of the imager;
in response to identifying the image of interest corresponding to the decode event, determining a default field of view as the default field of view corresponding to the image of interest; and
storing subsequent image of interest captured in the default field of view in the image set for use by the neural network.

20. The computer-implemented method of claim 18, further comprising:
not storing subsequent image of interests captured in a field of view different than the default field of view.

21. The computer-implemented method of claim 1, wherein identifying the image of interest from among the sequence of images of the object, further comprises:
identifying, at the one or more processors, a region of interest within the image of interest;
identifying an anomaly present in the region of interest;
determining an amount of the anomaly present in the region of interest and determining if the amount of the anomaly present in the region of interest exceeds a threshold value; and
when the amount of the anomaly exceeds the threshold value preventing storage of the image of interest in the image set.

22. The computer-implemented method of claim 1, further comprises capturing the image scan data of the object and capturing the sequence of images of the object using a camera imager.

23. The computer-implemented method of claim 1, further comprises capturing the image scan data of the object using a scanner and capturing the sequence of images of the object using an imager.
